(19) United States
(12) Patent Application Publication
(10) Pub. No.: US 2003/0073356 A1
(43) Pub. Date: Apr. 17, 2003

(54) Self-crimping solderless connector

(76) Inventor: Jay Victor, Pacifica, CA (US)

Correspondence Address: LARIVIERE, GRUBMAN & PAYNE, LLP, 1 LOWER RAGSDALE, BLDG. 1, SUITE 130, P.O. BOX 3140, MONTEREY, CA, 93942, US

(21) Appl. No.: 09/982,376

(22) Filed: Oct. 17, 2001

(51) Int. Cl. H01R 4/50

(52) U.S. Cl. 439/864

(57) ABSTRACT

Connector apparatus and method for fastening a wire removably and without the use of tools, having a wedging member pivotally coupled with a base member, defining a gap for receiving of a bare wire such that wedging member presses wire against the base member.

### COPYRIGHT STATEMENT

A portion of the disclosure of this patent document contains material to which a claim of copyright protection is made. The copyright owner has no objection to the facsimile reproduction of the patent document or the patent disclosure as it appears in the U.S. Patent and Trademark office file or records, but reserves all other copyright rights.

### BACKGROUND OF THE INVENTION

It is often desirable to fasten a connector to a wire when in the field. Traditional methods of fastening connectors require tools and, for some methods, expertise. There is a need for a connector that can be securely fastened to a wire without the use of tools.

### SUMMARY OF THE INVENTION

The self-crimping solderless connector is capable of fastening to a wire very securely without the use of tools. The connector has a wedge which pivots above a base. The wedge presses a wire very tightly against the base, securing the wire to the connector. Preferably the wedge pivots in a cam action to provide a high level of pressure.

### BRIEF DESCRIPTION OF DRAWINGS

FIG. 1 is a perspective view of a preferred embodiment of the invention.

FIG. 2 is a side view in partial section of the embodiment of FIG. 1 shown in operation, before the securing of a wire.

FIG. 3 is a side view in partial section of the embodiment of FIG. 1 shown in operation, after the securing of a wire.

FIG. 4 is a side view in partial section of the embodiment of FIG. 1 shown in operation with the use of a shim, before the securing of a wire.

FIG. 5 is a side view in partial section of the embodiment of FIG. 1 shown in operation with the use of a shim, after the securing of a wire.

FIG. 6 is a perspective view of an alternative embodiment of the invention.

FIG. 7 is a side view in partial section of the embodiment of FIG. 6 shown in operation, after the securing of a wire.

### DETAILED DESCRIPTION

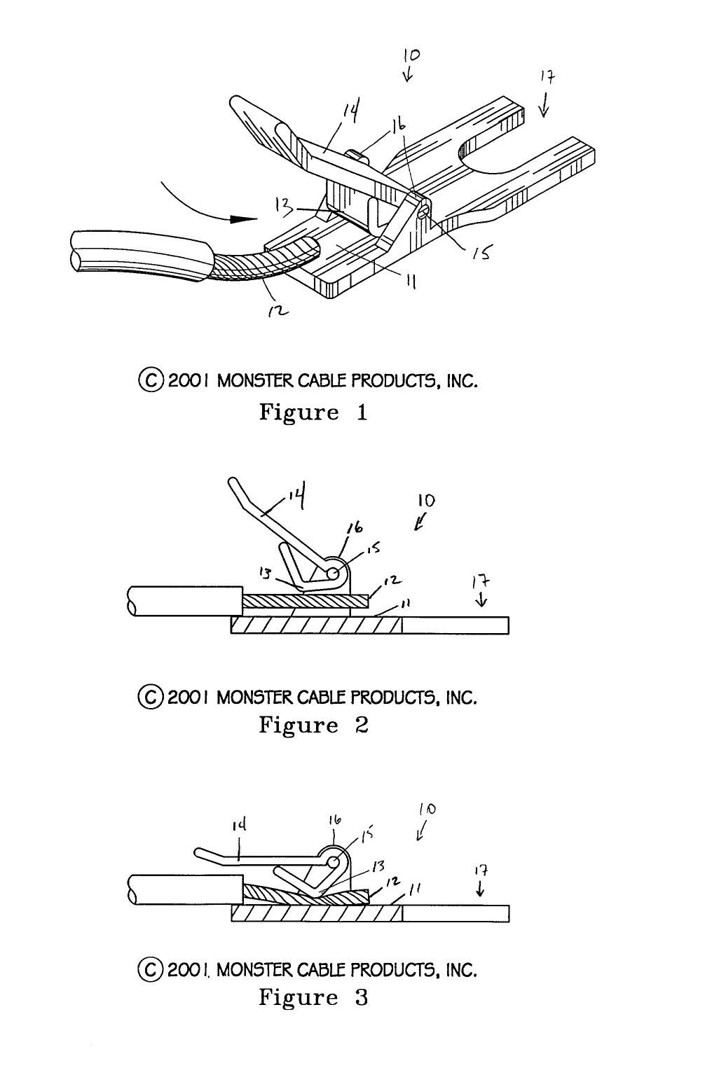

A preferred embodiment of the invention is shown in FIG. 1. A self-crimping solderless connector 10 is shown, having a base member 11 against which a wire 12 will be pressed by the wedge member 13. The wire 12 may be stranded or solid. The wedge member 13 may be of one piece with a lever 14. The lever and wedge piece may be formed of solid material bent into shape or from solid material molded, cast, or machined. A suitable solid material would be metal or a hard plastic. The wedge 13 is pivotally coupled with the base member by a pin 15 installed in projecting members 16 which project from the base member 11. The projecting members may be formed by casting or machining, by bending up the edges of the base member, or by attachment of pieces to the base member.

The connector has a connection end 17 which is formed into the shape of a useful connector. The shape of a spade lug is illustrated in FIG. 1. The connection end could also be a banana plug or other type of plug or socket.

The invention is useful for placing an electrically conductive connector on an electrically conductive wire, without tools, and creating an electrically conductive secure connection which is airtight or nearly airtight. In order to create an electrically conductive connection, the base member 11 should be made of, or coated or plated with, an electrically conductive material such as a metal. An electrically conductive wire should be stripped of any insulation covering the portion of the wire to be securely connected to the connector.

The operation of the invention is illustrated in FIGS. 2 & 3. FIG. 2 shows the invention in operation before the wire is secured. FIG. 3 shows the invention in operation after the wire is secured.

The wire 12 is placed in the opening or gap defined between the base member 11 and the wedge member 13. The lever 14 is pressed in order to force the wedge member 13 against the wire 12, which forces the wire against the base member 11.

The wedge member 13 pivots about the axis of the pivot pin 15 in such a way that it functions as a cam. This cam action provides for a very tight and secure connection by pressing the wedge member 13 very tightly against the wire 12 which is in turn pressed very tightly against the base member 11. The cam action provides an increase of pressure.

The invention can be used without the necessity of using tools and is therefore convenient for use in the field. The secure connection of the wire to the connector is reversible without the use of tools. The connector can be removed from the wire and both the connector and wire may be reused for other connections.

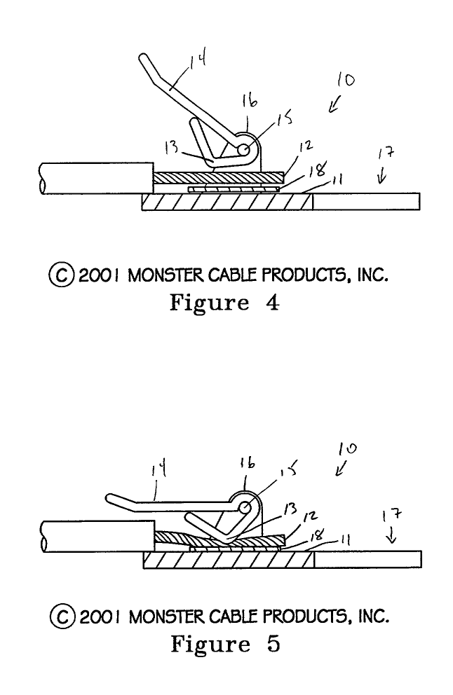

Referring to FIGS. 4 & 5, the invention can be used with a small-gauged wire through the use of a shim 18 placed in the area between the base member 11 and the wedge member 13. The shim 18 allows the cam action of the wedge member 13 to put greater pressure on the wire 12.

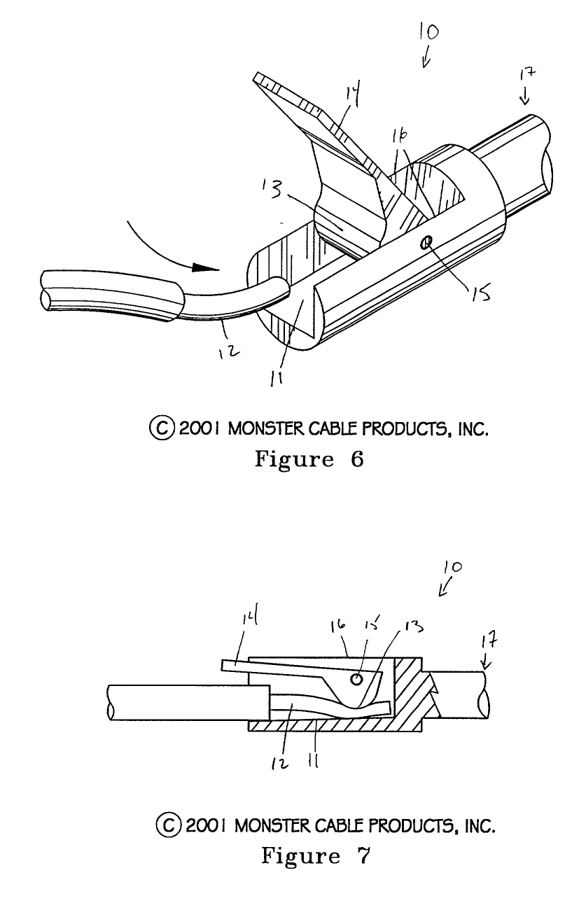

An alternative embodiment of the invention is illustrated in FIG. 6. A main body formed by molding, casting, or machining has a base member portion 11 and projecting member portions 16 and a connection end 17. Another molded, cast, or machined piece has a lever 14 and a wedge member 13. The wedge member pivots about a pivot pin 15 in a cam action. A wire 12 is placed in the area between the base member 11 and the wedge member 13.

FIG. 7 shows the alternative embodiment of the invention shown in FIG. 6 in operation, after the wire 12 is secured by pressing the lever 14 which pivots the wedge member 13 about the pivot pin 15 in a cam action, thereby pressing the wedge member very tightly against the wire and pressing the wire very tightly against the base member 11.

A splice connector may be made by providing more than one wedge and lever on a common base. A first wire is fastened by a first wedge, and a second wire is fastened by a second wedge.

While this invention has been described in detail with particular reference to its preferred embodiments, the principles and modes of operation of the invention have been described in this specification. The invention should not be construed as being limited to the particular forms disclosed, which are illustrative rather than restrictive. Modifications, variations, and changes may be made by those skilled in the art without departure from the spirit and scope of the invention as described by the following claims.

I claim:

1. A connector for fastening a wire, comprising:
at least one base member;
at least one wedging member pivotally coupled with and disposed adjacent to said base member;
said wedging member and said base member defining a gap for receiving of a bare wire such that said wedging member is operative to press said wire against said base member.

2. The connector of claim 1, wherein said wedging member is pivotally coupled with said base member to form a cam.

3. The connector of claim 2, wherein said base member is generally planar.

4. The connector of claim 3, wherein said base member is electrically conductive.

5. The connector of claim 1, wherein said base member is generally planar.

6. The connector of claim 1, wherein said base member is electrically conductive.

7. The connector of claim 1, wherein said wedging member is pivotally coupled with said base member to form a cam and said base member is electrically conductive.

8. The connector of claim 1, further comprising a shim to decrease the size of said gap for receiving of a bare wire.

9. The connector of claim 1, further comprising an electrically conductive shim to decrease the size of said gap for receiving of a bare wire.

10. A method for fastening a wire, comprising:
providing at least one base member;
providing at least one wedging member pivotally coupled with and disposed adjacent to said base member;
said wedging member and said base member defining a gap for receiving of a bare wire such that said wedging member is operative to press said wire against said base member.

11. The method of claim 10, wherein said wedging member is pivotally coupled with said base member to form a cam.

12. The method of claim 11, wherein said base member is generally planar.

13. The method of claim 12, wherein said base member is electrically conductive.

14. The method of claim 10, wherein said base member is generally planar.

15. The method of claim 10, wherein said base member is electrically conductive.

16. A connector for fastening a wire, comprising:
base member means providing a surface against which to press said wire;
wedging member means for pressing said wire against said base member means;
said wedging member means pivotally coupled with and disposed adjacent to said base member means;
said wedging member means and said base member means defining a gap for receiving of a bare wire such that said wedging member means is operative to press said wire against said base member means.

17. A connector for fastening a wire, comprising:
at least one electrically conductive base member;
at least one wedging member pivotally coupled with and disposed adjacent to said base member, forming a cam;
said wedging member and said base member defining a gap for receiving of a bare wire such that said wedging member is operative to press said wire against said base member.
